(19) United States
(12) Patent Application Publication
(10) Pub. No.: US 2013/0262814 A1
(43) Pub. Date: Oct. 3, 2013

(54) Mapping Memory Instructions into a Shared Memory Address Place

(71) Applicants: Anthony Asaro, Toronto (CA); Kevin Normoyle, Los Gatos, CA (US); Mark Hummel, Franklin, MA (US)

(72) Inventors: Anthony Asaro, Toronto (CA); Kevin Normoyle, Los Gatos, CA (US); Mark Hummel, Franklin, MA (US)

(73) Assignees: Advanced Micro Devices, Inc., Sunnyvale, CA (US); ATI Technologies ULC, Markham (CA)

(21) Appl. No.: 13/588,790

(22) Filed: Aug. 17, 2012

Related U.S. Application Data
(60) Provisional application No. 61/617,392, filed on Mar. 29, 2012.

(51) Int. Cl. G06F 12/10

(52) U.S. Cl. 711/206; 711/202; 711/E12.059

(57) ABSTRACT

Embodiments of the present invention provide a method of a first processor using a memory resource associated with a second processor. The method includes receiving a memory instruction from a first processor process, wherein the memory instruction refers to a shared memory address (SMA) that maps to a second processor memory. The method also includes mapping the SMA to the second processor memory, wherein the mapping produces a mapping result and providing the mapping result to the first processor.

### BACKGROUND

1. Field of the Invention

The present invention generally relates to computer systems. More particularly, the present invention is directed to architecture and methods for unifying computational components of a computer system.

2. Related Art

The desire to use a graphics processing unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market (e.g., notebooks, mobile smart phones, tablets, etc.) and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available primarily for the acceleration of graphics. These constraints arose from the fact that GPUs did not have as rich a programming ecosystem as CPUs. Their use, therefore, has been mostly limited to two dimensional (2D) and three dimensional (3D) graphics and a few leading edge multimedia applications, which are already accustomed to dealing with graphics and video application programming interfaces (APIs).

With the advent of multi-vendor supported OpenCL® and DirectCompute®, standard APIs and supporting tools, the limitations of the GPUs in traditional applications has been extended beyond traditional graphics. Although OpenCL and DirectCompute are a promising start, there are many hurdles remaining to creating an environment and ecosystem that allows the combination of a CPU and a GPU to be used as fluidly as the CPU for most programming tasks.

Existing computing systems often include multiple processing devices. For example, some computing systems include both a CPU and a GPU on separate chips (e.g., the CPU might be located on a motherboard and the GPU might be located on a graphics card) or in a single chip package. Both of these arrangements, however, still include significant challenges associated with (i) efficient scheduling, (ii) providing quality of service (QoS) guarantees between processes, (iii) programming model, (iv) compiling to multiple target instruction set architectures (ISAs), and (v) separate memory systems,—all while minimizing power consumption.

Although the existing computer systems use unified platforms that combine the separate memory systems, these unified systems are not devoid of challenges. For example, these unified systems are unable to provide an environment where resources associated the CPU or the GPU can efficiently accommodate shared memory address space.

### BRIEF SUMMARY OF THE EMBODIMENTS

What is needed, therefore, is a method and system for efficiently sharing memory address space accessible by a CPU and a GPU so that memory resources associated with the CPU can execute instructions generated by the GPU, or vice versa.

Although GPUs, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner compared to conventional CPUs, conventional GPUs, software and/or combinations thereof.

Embodiments of the present invention, under certain circumstances, provide a method of a CPU using a memory resource associated with an APD. The method includes receiving a memory instruction from a CPU process, wherein the memory instruction refers to a shared memory address (SMA) that maps to the APD. The method also includes mapping the SMA to the second processor memory, wherein the mapping produces a mapping result and providing the mapping result to the APD. The first processor uses the mapping result to perform the memory instruction.

Additional features and advantages of the present invention, as well as the structure and operation of various embodiments of the present invention, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the present invention and to enable a person skilled in the pertinent art to make and use the present invention. Various embodiments of the present invention are described below with reference to the drawings, wherein like reference numerals are used to refer to like elements throughout.

FIG. 1A is a block diagram of an embodiment of a processing system in accordance with the present invention.

FIG. 1B is a block diagram of APD 104 shown in FIG. 1A.

FIG. 2 depicts a system of performing a memory instruction using a memory instruction mapper and a shared memory address space.

FIG. 3 depicts a system of reading a permission for a page table page.

FIG. 4 depicts a system of storing a mapping result.

FIG. 5 shows a flowchart illustrating a method of an APD using a CPU memory in a computer arrangement having a CPU and the APD according to an embodiment of the present invention.

### DETAILED DESCRIPTION OF THE EMBODIMENTS

The term “embodiments of the present invention” does not require that all embodiments of the present invention include the discussed feature, advantage or mode of operation. Alternate embodiments may be devised without departing from the scope of the present invention, and well-known elements of the present invention may not be described in detail or may be omitted so as not to obscure the relevant details of the present invention. In addition, the terminology used herein is for the purpose of describing particular embodiments only and is not intended to be limiting of the present invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

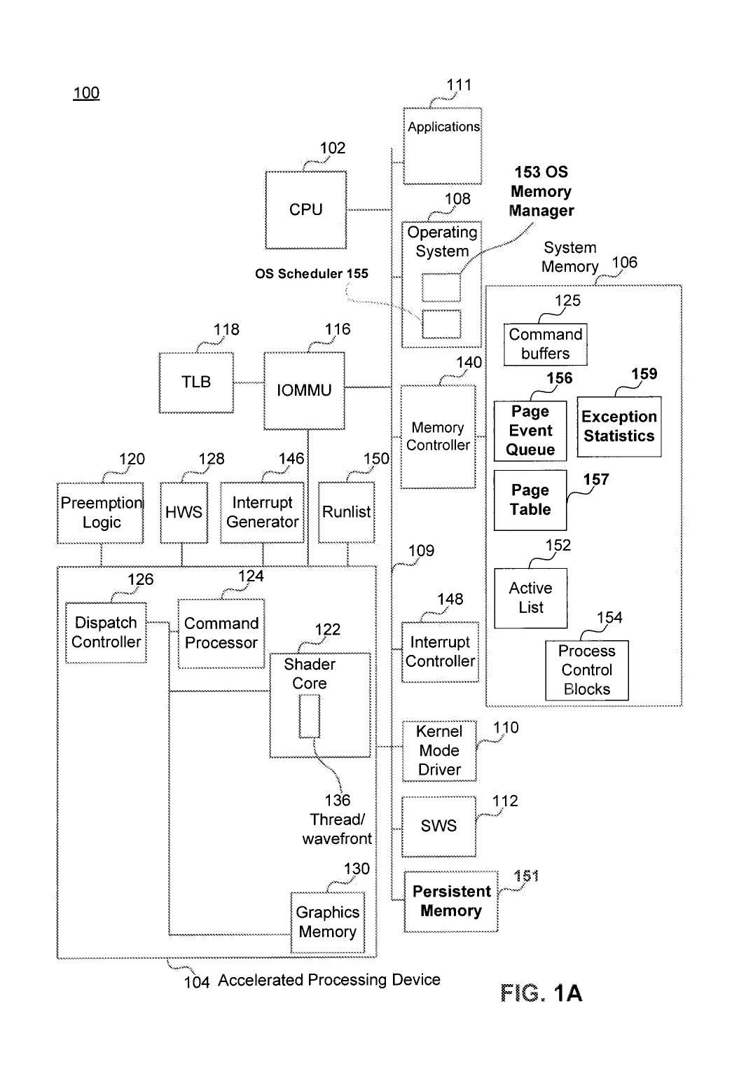

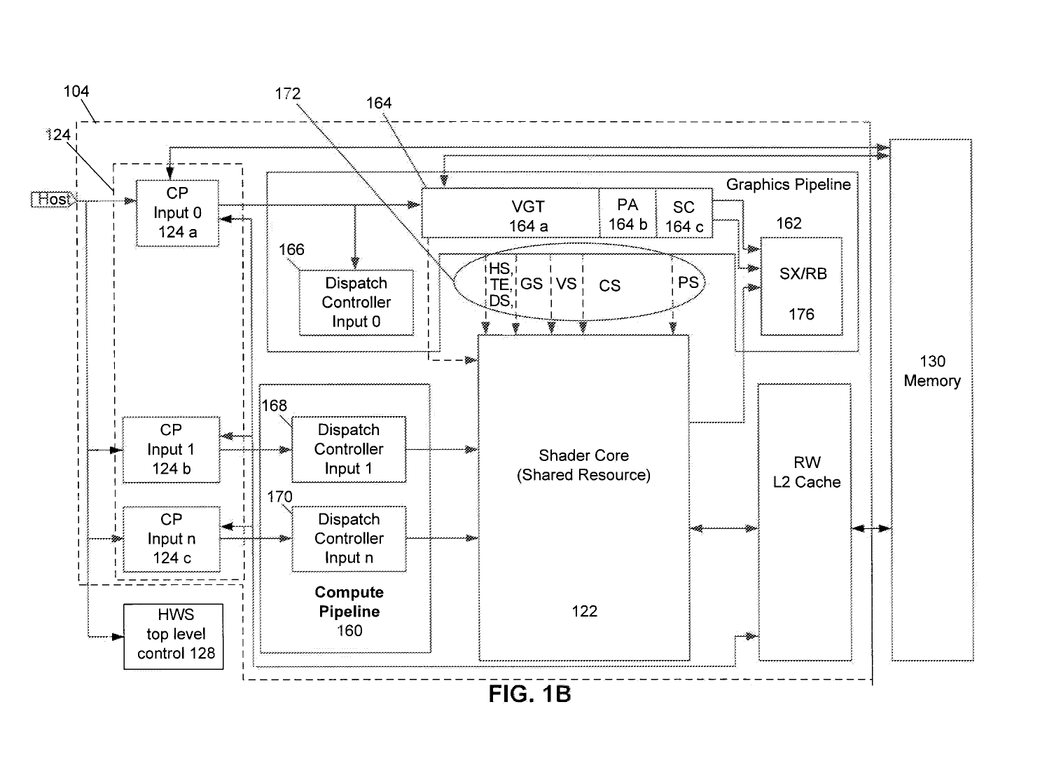

FIG. 1A is a block diagram of an exemplary unified computing system 100 that includes a CPU 102 and an APD 104. In an embodiment of the present invention, the system 100 is formed on a single silicon die, combining the CPU 102 and APD 104 to provide a unified programming and execution environment. This environment enables the APD to be used as fluidly as the CPU for some programming tasks. However, it is not an absolute requirement of this invention that the CPU and APD be formed on a single silicon die. In some embodiments, they may be formed separately and be mounted on the same or different substrates.

In one example, system 100 also includes a system memory 106, an operating system (OS) 108, and a communication infrastructure 109. The OS 108 and the communication infrastructure 109 are described in greater detail below.

The system 100 also includes a kernel mode driver (KMD) 110, a software scheduler (SWS) 112, and a memory management unit, such as input/output memory management unit (IOMMU) 116. CPU 102 and APD 104 can be implemented on a single integrated circuit chip or on multiple chips. A person skilled in the relevant art will appreciate that system 100 may include one or more software, hardware, and firmware components in addition to, or different from, that shown in the embodiment shown in FIG. 1A.

CPU 102 can include (not shown) one or more of a control processor, field programmable gate array (FPGA), application specific integrated circuit (ASIC), or digital signal processor (DSP). CPU 102, for example, executes the control logic, including the OS 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104. CPU 102 can include one or more single or multi core CPUs.

APD 104 includes its own compute units (not shown), such as, but not limited to, one or more single instruction multiple data (SIMD) processing cores. Each APD compute unit can include one or more of scalar and/or vector floating-point units and/or arithmetic and logic units (ALU). The APD compute unit can also include special purpose processing units (not shown) such as inverse-square root units and sine/cosine units. The APD compute units are referred to herein collectively as shader core 122.

Having one or more SIMD compute units, in general, makes APD 104 ideally suited for execution of data-parallel tasks such as are common in graphics processing.

A set of related operations executed on a compute unit can also be referred to as a compute kernel. In graphics pipeline operations, such as pixel processing, and other parallel computation operations, can require that the same instruction stream or compute kernel can be performed on streams or collections of input data elements. Respective instantiations of the same compute kernel can be executed concurrently on multiple compute units in shader core 122 in order to process such data elements in parallel. A single data item within a stream or collection to which a compute kernel is applied is referred to as a work-item. A set of work-items across which the instructions of a compute kernel are applied in lock-step within a single SIMD processing core is referred to as a thread. Stated another way, the term thread refers to a single instance of a program execution with a unique data state.

In an illustrative embodiment, each compute unit (e.g., SIMD processing core) can execute a respective instantiation of a particular thread or process to process incoming data.

A group of threads that are processed under a shared instruction state in a SIMD-style process are referred to as a wavefront. For example, shader core 122 can simultaneously execute a predetermined number of wavefronts 136, each wavefront 136 comprising a predetermined number of threads.

APD 104 includes its own memory, such as graphics memory 130. Graphics memory 130 provides a local memory for use during computations in APD 104, and each compute unit of the shader core 122 may have its own local data store (not shown). In one embodiment, APD 104 can include access to local graphics memory 130, as well as access to the system memory 106. In another embodiment, APD 104 can also include access to dynamic random access memory (DRAM) or other such memories attached directly to the APD separately from system memory 106.

APD 104 also includes a command processor (CP) 124. CP 124 controls the processing within APD 104. CP 124 also retrieves instructions to be executed from command buffers 125 in system memory 106 and coordinates the execution of those instructions on APD 104.

In one example, CPU 102 inputs commands based on applications 111 into appropriate command buffers 125. A plurality of command buffers 125 can be maintained with each process scheduled for execution on the APD having its own command buffer 125.

Command processor 124 can be implemented in hardware, firmware, or software, or a combination thereof. In one embodiment, command processor 124 is implemented as a RISC engine with microcode for implementing logic including scheduling logic.

APD 104 may also include a dispatch controller 126. Dispatch controller 126 includes logic to initiate threads and wavefronts in the shader core. In some embodiments, dispatch controller 126 can be implemented as part of command processor 124.

System 100 also includes a hardware scheduler (HWS) 128 for selecting a process from a run list 150 for execution on API) 104, HWS 128 can select processes from run list 150 using round robin methodology, based upon priority level, or based on other scheduling policies. By way of example, the priority level can be dynamically determined. HWS 128 can also include functionality to manage the run list, for example, by adding new processes and by deleting existing processes from a run-list. The run list management logic of HWS 128 is sometimes referred to as a run list controller (RLC).

In various embodiments of the present invention, when HWS 128 initiates the execution of a process from run list 150, CP 124 begins retrieving and executing instructions from the corresponding command buffer 125. In some instances, command processor 124 can generate one or more commands to be executed within APD 104, which correspond with each command received from CPU 102. In one embodiment, command processor 124, together with other components, implements a prioritizing and scheduling of commands on APD 104 in a manner that improves or maximizes the utilization of the resources of APD 104 resources and/or system 100.

APD 104 can have access to, or may include, an interrupt generator 146. Interrupt generator 146 can be configured by APD 104 to interrupt the OS when interrupt events, such as page faults, are encountered by APD 104. For example, APD 104 can rely on interrupt generation logic within IOMMU 116 to create the page fault interrupts noted above.

APD 104 can also include preemption and context switch logic 120, which includes logic to preempt a process currently running within shader core 122. More specifically, context switch logic 120 can include functionality to coordinate the preemption, for example, by stopping the process and saving the current state of the process (e.g., shader core 122 state, CP 124 state).

Preemption and context switch logic 120 can also include logic to context switch another process into the APD 104. The functionality to context switch another process into running on the APD 104 may include instantiating the process, for example, through the command processor and dispatch controller to run on APD 104, restoring any previously saved state for that process, and starting its execution.

System memory 106 includes non-persistent memory such as DRAM. System memory 106 can store, e.g., processing logic instructions, constant values, and variable values during execution of portions of applications or other processing logic. For example, in one embodiment, parts of control logic to perform one or more operations on CPU 102 can reside within system memory 106 during execution of the respective portions of the operation by CPU 102. The term “processing logic” or “logic,” as used herein, refer to control flow instructions, instructions for performing computations, and instructions for associated access to resources.

During execution, respective applications, OS functions, processing logic instructions, and system software can reside in system memory 106. Control logic instructions fundamental to OS 108 will generally reside in system memory 106 during execution. Other software instructions, including, for example, kernel mode driver 110 and software scheduler 112 can also reside in system memory 106 during execution of system 100.

System memory 106 includes command buffers 125 that are used by CPU 102 to send commands to APD 104. System memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to system memory 106 can be managed by a memory controller 140, which is coupled to system memory 106. For example, requests from CPU 102, or from other devices, for reading from or for writing to system memory 106 are managed by the memory controller 140.

IOMMU 116 is a multi-context memory management unit. IOMMU 116 includes logic to perform virtual to physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in system memory 106.

Communication infrastructure 109 interconnects the components of system 100 as needed. Communication infrastructure 109 can include (not shown) one or more of a Peripheral Component Interconnect (PCI) bus, extended PCI (PCI-E) bus, advanced microcontroller bus architecture (AMBA) bus, advanced graphics port (AGP), or such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

OS 108 includes components and software/firmware providing functionality to manage the hardware components of system 100 and to provide common services. In various embodiments, processes defined by OS 108 can execute on CPU 102 and provide common services. These common services can include, for example, scheduling applications for execution within CPU 102, fault management, interrupt service, as well as processing the input and output of other applications.

In various embodiments, based on interrupts generated by an interrupt controller such as interrupt controller 148, OS 108 invokes an appropriate interrupt handling routine. For example, upon detecting a page fault interrupt, OS 108 may invoke an interrupt handler to initiate loading of the relevant page into system memory 106 and to update corresponding page tables.

OS 108 is configured to have functionality to protect system 100 by ensuring that access to hardware components is mediated through OS managed kernel functionality. In effect, OS 108 ensures that applications, such as applications 111, run on. CPU 102 in user space. OS 108 also ensures that applications 111 invoke kernel functionality provided by the OS to access hardware and/or input/output functionality.

According to an embodiment of the present invention, the operating system includes an OS memory manager 153 and an OS scheduler 155. OS memory manager 153 has the functionality required to manage memory objects such as, but not limited to, page tables 157 and page event queues 156. Page tables 157 are tables that indicate the location of pages currently loaded in memory. Page event queue 156 is a queue in which page related events, such as page fault events, are enqueued by other devices, such as IOMMU 116, in order to communicate page related information to the OS. OS scheduler 155 includes the functionality, according to an embodiment, to determine the status of page faults and to determine if a GPU context switch should be initiated in response to a page fault.

KMD 110 implements an application program interface (API) through which CPU 102, or applications executing on CPU 102 or other logic, can invoke APD 104 functionality. For example, KMD 110 can enqueue commands from CPU 102 to command buffers 125 from which APD 104 will subsequently retrieve the commands. Additionally, KMD 110 can, together with SWS 112, perform scheduling of processes to be executed on APD 104. SWS 112, for example, can include logic to maintain a prioritized list of processes to be executed on the APD.

In other embodiments of the present invention, applications executing on CPU 102 can entirely bypass KMD 110 when enqueuing commands.

In some embodiments, SWS 112 maintains an active list 152 in system memory 106 of processes to be executed on APD 104. SWS 112 also selects a subset of the processes in active list 152 to be managed by HWS 128 in the hardware. In an illustrative embodiment, this two level run list of processes increases the flexibility of managing processes and enables the hardware to rapidly respond to changes in the processing environment. In another embodiment, information relevant for running each process on APD 104 is communicated from CPU 102 to APD 104 through process control blocks (PCB) 154.

Processing logic for applications, OS, and system software can include instructions specified in a programming language such as C and/or in a hardware description language such as Verilog, RTL, or netlists, to enable ultimately configuring a manufacturing process through the generation of maskworks/photomasks to generate a hardware device embodying aspects of the present invention described herein.

A person skilled in the relevant art will understand, upon reading this description, that computing system 100 can include more or fewer components than shown in FIG. 1A. For example, computing system 100 can include one or more input interfaces, non-volatile storage, one or more output interfaces, network interfaces, and one or more displays or display interfaces.

FIG. 1B is an embodiment showing a more detailed illustration of APD 104 shown in FIG. 1A. In FIG. 1B, CP 124 can include CP pipelines 124a, 124b, and 124c. CP 124 can be configured to process the command lists that are provided as inputs from command buffers 125, shown in FIG. 1A. In the exemplary operation of FIG. 1B, CP input 0 (124a) is responsible for driving commands into a graphics pipeline 162. CP inputs 1 and 2 (124b and 124c) forward commands to a compute pipeline 160. Also provided is a controller mechanism 166 for controlling operation of HWS 128.

In FIG. 1B, graphics pipeline 162 can include a set of blocks, referred to herein as ordered pipeline 164. As an example, ordered pipeline 164 includes a vertex group translator (VGT) 164a, a primitive assembler (PA) 164b, a scan converter (SC) 164c, and a shader-export, render-back unit (SX/RB) 176. Each block within ordered pipeline 164 may represent a different stage of graphics processing within graphics pipeline 162. Ordered pipeline 164 can be a fixed function hardware pipeline. Other implementations can be used that would also be within the spirit and scope of the present invention.

Although only a small amount of data may be provided as an input to graphics pipeline 162, this data will be amplified by the time it is provided as an output from graphics pipeline 162. Graphics pipeline 162 also includes DC 166 for counting through ranges within work-item groups received from CP pipeline 124a. Compute work submitted through DC 166 is semi-synchronous with graphics pipeline 162.

Compute pipeline 160 includes shader DCs 168 and 170. Each of the DCs 168 and 170 is configured to count through compute ranges within work groups received from CP pipelines 124b and 124c.

The DCs 166, 168, and 170, illustrated in FIG. 1B, receive the input ranges, break the ranges down into workgroups, and then forward the workgroups to shader core 122.

Since graphics pipeline 162 is generally a fixed function pipeline, it is difficult to save and restore its state, and as a result, the graphics pipeline 162 is difficult to context switch. Therefore, in most cases context switching, as discussed herein, does not pertain to context switching among graphics processes. An exception is for graphics work in shader core 122, which can be context switched.

After the processing of work within graphics pipeline 162 has been completed, the completed work is processed through a render back unit 176, which does depth and color calculations, and then writes its final results to memory 130.

Shader core 122 can be shared by graphics pipeline 162 and compute pipeline 160. Shader core 122 can be a general processor configured to run wavefronts. In one example, all work within compute pipeline 160 is processed within shader core 122. Shader core 122 runs programmable software code and includes various forms of data, such as state data.

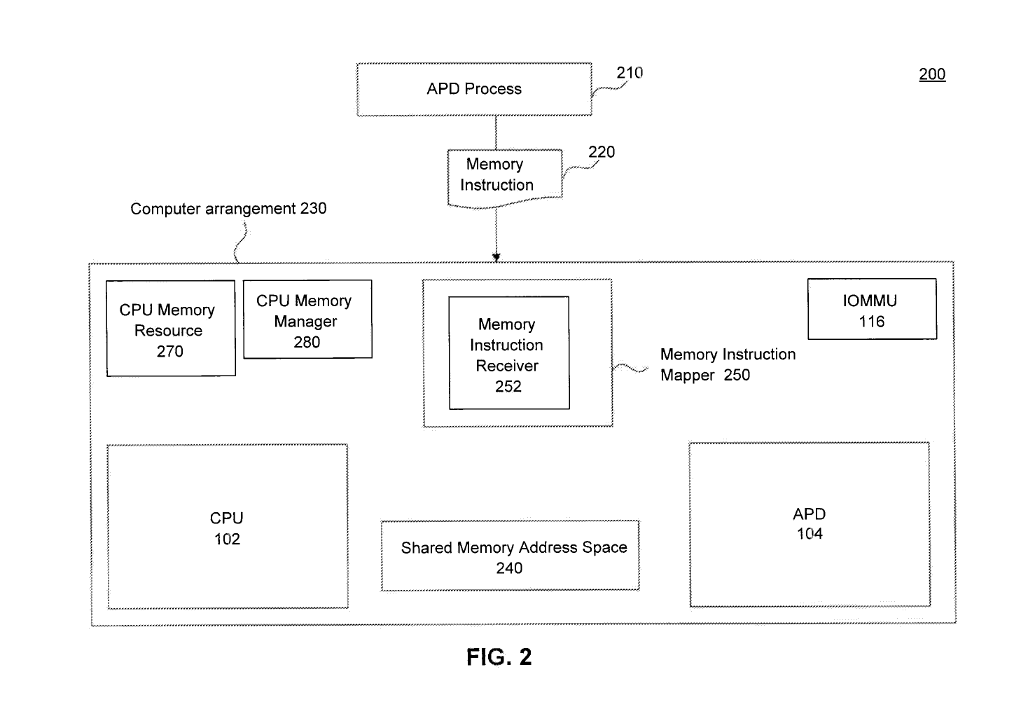

FIG. 2 is a block diagram of an exemplary system 200 in which embodiments of the present invention, or portions thereof, can be implemented. System 200 includes an APD process 210 and computer arrangement 230. Computer arrangement 230 includes CPU 102, memory instruction mapper 250, APD 104, shared memory address space 240, CPU memory resource 270, CPU memory manager 280 and IOMMU 116. Memory instruction mapper 250 includes memory instruction receiver 252. APD process 210 is shown generating memory instruction 220, such instruction transferred to computer arrangement 230 for execution.

Generally speaking, some embodiments described herein use memory instruction mapper 250 and shared memory address space 240 to map memory instruction 220 generated by APD 104 to physical memory resources. As noted with the description of FIG. 1A above, in an embodiment, portions of both the CPU and APD physical memory are available for use by memory instructions. For example, using approaches detailed herein, a memory instruction executed by APD process 210 is not limited to only accessing APD physical memory.

As noted in the description of FIG. 1A, one approach to enabling the sharing of physical memory detailed above, uses a shared memory address space 240 to access different physical memory resources. For example, rather than having an application use the conventional approach of explicitly marshalling memory between a CPU virtual address space and an APD virtual address space, the application can use shared memory address space 240. An application using both a CPU and an APD for execution, can have both CPU and APD memory instructions accessing the same shared memory address space 240.

Referring to FIG. 2, computer arrangement 230 uses memory instruction mapping. One approach to accessing the above-noted CPU memory resource 270 by memory instruction 220 generated by APD process 210 is to use memory instruction mapper 250 to map to CPU memory resource 270 with shared memory address space 240. CPU memory resource 270, mapped into shared memory address space 240 by embodiments, can be accessed by memory instruction 220.

According to a conventional approach of enabling the use of memory resources by different types of processors, before processing, memory values associated with a memory instruction must be copied and transferred from a physical memory portion associated with a first type of processor, e.g., APD 104, to another, pre-allocated physical memory portion associated with a second type of processor, e.g., CPU 102. After processing by the second type of processor, results are transferred back to a memory portion accessible to the first type of processor. In contrast to this conventional copy and transfer approach, embodiments of the present invention describe a memory instruction mapping system and method.

Memory instruction 220 originates with APD process 210, and contains a shared memory address (SMA) reference to shared memory address space 240. Memory instruction receiver 252 included in memory instruction mapper 250 receives memory instruction 220 from APD process 210. Memory instruction mapper 250 uses the SMA included in memory instruction 220 to map memory instruction 220 to CPU memory resource 270.

In an example, the SMA referenced by memory instruction 220 is used by memory instruction mapper 250 to direct the execution of memory instruction 220 to a particular address in CPU memory resource 270 accessible by computer arrangement 230. In this example, address range 13 to 20 in shared memory address space 240 is defined as the portion of the shared memory address space 240 allocated to CPU memory resource 270 and memory instruction 220 refers to address 15. Memory instruction 220 thus references an address in the above defined shared memory address space 240 that is allocated to CPU memory resource 270, and memory instruction mapper 250 maps memory instruction 220 to that memory resource.

As further depicted on FIG. 2, one approach used to reach CPU memory resource 270 is to route memory instruction 220 via IOMMU 116. The use of IOMMU 116 is determined by memory instruction mapper 250 based on the SMA reference in memory instruction 220. In another embodiment, IOMMU 116 receives memory instruction 220 based on memory instruction mapper 250, and then selects CPU memory resource 270 based on other criteria, e.g., the SMA, the originating process generating memory instruction or the type of memory instruction.

In a more detailed description of an embodiment, memory instruction mapper 250 maps memory instruction 220 to CPU memory resource 270 by requesting a page table mapping and then maps memory instruction 220 to CPU memory resource 270 based on that mapping. Memory instruction 220 references the SMA in shared memory address space 240 that is allocated to CPU memory resource 270. Memory instruction mapper 250 requests a page table mapping for page tables that refer to the address located in the portion of CPU memory resource 270 that is allocated to the SMA in shared memory address space 240. Memory instruction mapper 250 uses the requested page table mapping to map memory instruction 220 to CPU memory resource 270.

Memory instruction mapper 250 can map memory instruction 220 to CPU memory resource 270 by requesting a page table mapping from IOMMU 116. Memory instruction 220 references the SMA in shared memory address space that is allocated to CPU memory resource 270. The page tables requested in the page table mapping refer to the address located in the portion of CPU memory resource 270 that is allocated to the SMA in shared memory address space 240. IOMMU 116 obtains the page table mapping and provides the mapping to memory instruction mapper 250 such that memory instruction mapper 250 uses the requested page table mapping to map memory instruction 220 to CPU memory resource 270.

In an embodiment, memory instruction mapper 250 uses IOMMU 116 to access physical memory resources. As described in FIG. 1A above, IOMMU 116 includes logic to perform virtual to physical address translation for memory page access for devices including APD 104. One approach used by IOMMU 116 to enable the use of shared memory address space 240, uses full x86 page tables to allow x86 user code and APD code to share the same memory page tables. Because of this page table sharing, in an embodiment, an APD context corresponds to standard x86 user context. Using the IOMMU 116, each APD context can participate fully in paging translations and protections performed by standard system operation. APD 104 can also be enabled to use standard TLB translation caching techniques. Because of this expanded use of page tables by embodiments, operating system 108 may be required to propagate page invalidations and page table flushes to IOMMU 116.

As would be appreciated by one having skill in the relevant art(s), given the description herein, the approaches described above, using shared memory address space 240 allows, for example, a pointer in APD process 210 to access both CPU memory resource 270 and APD physical memory in shared memory address space 240. In APD process 210, a pointer that references shared memory address space 240 resolves to the same physical memory address regardless of whether CPU memory resource 270 or a memory resource allocated to APD 104 is used.

Because APD process 210 operates in a single shared memory address space 240, the conventional need for multiple representations of addresses is removed in some implementations. As noted above, the programmer no longer needs to explicitly marshal memory between an address space for a memory resource associated with CPU 102 and an address space for a memory resource associated with APD 104. Rather shared memory address space 240 can be accessed by memory resources associated with both CPU 102 and APD 104.

In an embodiment, shared memory address space 240 is referenced by a full 64 bit virtual address. In another embodiment, shared memory address space 240 is internally limited to 48 bits, e.g. sign extended to 64 bits from bit 47, in the same manner as a x86-64 CPU.

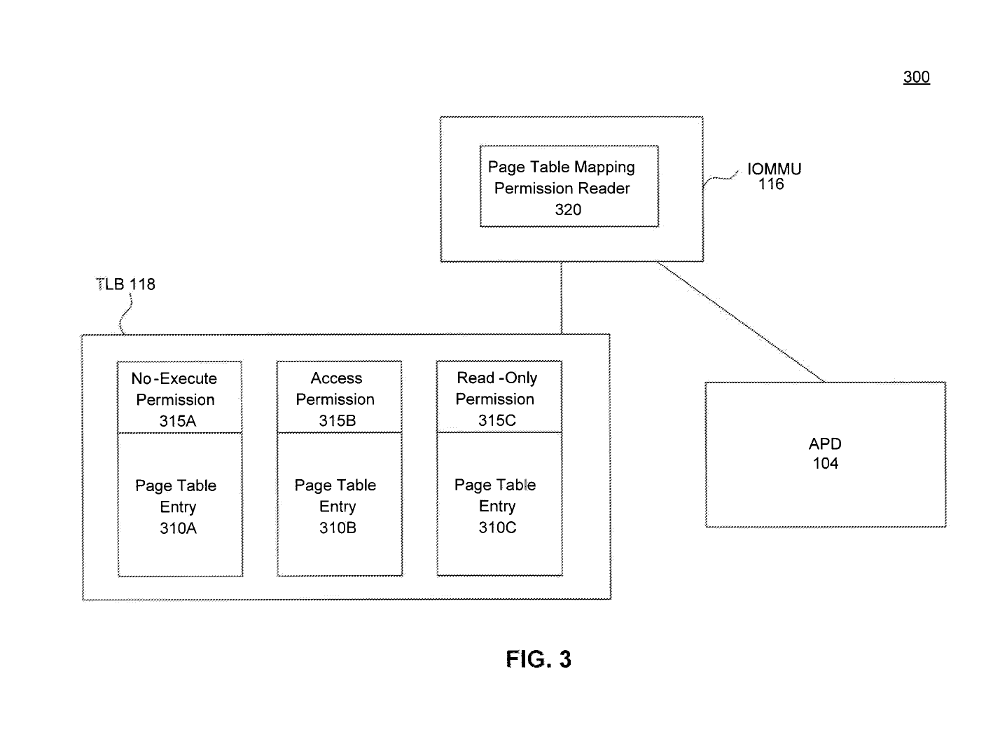

FIG. 3 depicts a system 300, such system having IOMMU 116, TLB 118 and APD 104. IOMMU 116 is shown having page table mapping permission reader 320. TLB 118 is shown having page table entries (PTE) 310A-C. Each PTE 310A-C is shown having an associated example PTE permission: no-execute permission 315A, access permission 315B and read-only permission 315C, respectively. The PTE permissions shown on FIG. 3 are intended to be non-limiting, and illustrative of types of operations performed by different embodiments.

Using a process similar to that described with reference to FIG. 2 above, memory instruction 220 originates with APD process 210, and contains a shared memory address reference (SMA) to shared memory address space 240. Memory instruction mapper 250 uses the included SMA to map memory instruction 220 to CPU memory resource 270. The particular SMA referenced by memory instruction 220 is used by memory instruction mapper 250, to direct the execution of memory instruction 220 to a particular address in CPU memory resource 270 accessible by computer arrangement 230.

In an embodiment, memory instruction mapper 250 requests a page table mapping for page tables that refers to the address located in the portion of CPU memory resource 270 that is allocated to the SMA in shared memory address space 240. Memory instruction mapper 250 uses the requested page table mapping to map memory instruction 220 to CPU memory resource 270.

Traditionally, CPU memory manager 280 manages page table mapping requests when memory instructions generated by CPU processes are to be executed by portions of the CPU system memory. CPU memory manager 280 supports permissions for x86 system page tables. CPU memory manager 280 receives the x86 page table mapping request and determines whether the particular x86 page table mapping requested is accessible to the memory instruction. When CPU memory manager 280 determines the x86 page table mapping requested is accessible to the memory instruction, a memory instruction is mapped into CPU system memory based on the x86 page table mapping. When CPU memory manager 280 determines the x86 page table mapping requested is not accessible to the memory instruction, CPU memory manager 280 generates a page fault and a memory instruction is not mapped into CPU system memory.

In conventional approaches, APD 104 does not support a similar permission structure used by CPU 102 and managed by CPU memory manager 280. In such conventional approaches, memory instructions generated by an APD processes can access APD memory without regulation as to whether an APD process should have permission to access APD memory. In such a conventional approach, an APD process can execute writes to APD memory without permission restrictions. As described below, in contrast to this conventional approach, embodiments using shared memory address space 240 provide a permission structure to memory instructions referencing SMAs in shared memory address space 240.

As describe above, in an embodiment, memory instruction mapper 250 requests a page table mapping for page tables that refers to the address located in the portion of CPU memory resource 270 that is allocated to the SMA in shared memory address space 240. With this page table mapping, memory instruction mapper 250 can receive page table permissions for the mapped pages. When performing mapping operations, an embodiment of memory instruction mapper 250 operates subject to page table permissions. As would be appreciated by one having skill in the relevant art(s), given the description herein, this approach allows page table permissions to regulate whether memory instruction mapper 250 may map memory instruction into CPU memory resource 270 in an approach similar to the approach used by CPU 102.

In a an example, memory instruction mapper 250 maps memory instruction 220 generated by APD process 210 into CPU memory resource 270. Memory instruction mapper 250 requests the page table mapping for page tables that refer to the address located in the portion of CPU memory resource 270 that is allocated to the SMA in shared memory address space 240. The page table permissions associated with the requested page table mapping allow memory instruction mapper 250 to map memory instruction 220 into the portion of CPU memory resource 270 that is allocated to the SMA in shared memory address space 240. Subject to the permission, memory instruction mapper 250 maps memory instruction 220 generated by APD process 210 into CPU memory resource 270.

In another example, instead of allowing access, the page table permissions associated with the requested page table mapping can deny memory instruction mapper 250 permission to map memory instruction 220 into the portion of CPU memory resource 270 that is allocated to the SMA in shared memory address space 240. Subject to the permission, memory instruction mapper 250 receives a page fault and is denied permission to map memory instruction 220 generated by APD process 210 into CPU memory resource 270. It would be appreciated by one having skill in the relevant art(s), given the description herein, that this permission restriction function in APD memory instruction mapping can also be performed by different parts of computer arrangement 230.

In an example referring to FIGS. 2 and 3, IOMMU 116 uses the page table permissions to restrict memory instruction mapper 250. Memory instruction mapper 250 requests a page table mapping for page tables from IOMMU 116 and based on that request IOMMU 116 either provides memory instruction mapper 250 with the page table mapping or denies the page table mapping to memory instruction mapper 250. Memory instruction 220 references the SMA in shared memory address space 240 that is allocated to CPU memory resource 270. Memory instruction mapper 250 requests a page table mapping for page tables from IOMMU 116 that refers to the address located in the portion of CPU memory resource 270 that is allocated to the SMA in shared memory address space 240. Based on that request, IOMMU 116 either grants permission to memory instruction mapper 250 to receive the page table mapping or denies memory instruction mapper 250 permission to receive the page table mapping.

In a variation of the IOMMU 116 example above, memory instruction mapper 250 receives the requested page table mapping from IOMMU 116 and maps memory instruction 220 generated by APD process 210 into CPU memory resource 270. In this example, memory instruction mapper 250 requests from IOMMU 116 the page table mapping for page tables that refer to the address located in the portion of CPU memory resource 270 that is allocated to the SMA in shared memory address space 240.

The page table permissions associated with the requested page table mapping allow memory instruction mapper 250 to map memory instruction 220 into the portion of CPU memory resource 270 that is allocated to the SMA in shared memory address space 240. IOMMU honors the page table permissions associated with the requested page table mapping and provides memory instruction mapper 250 with the page table mapping. Memory instruction mapper 250 is then able to map memory instruction 220 generated by APD process 210 into CPU memory resource 270.

In another example, instruction mapper 250 receives a page fault propagated by IOMMU 116 through to memory instruction mapper 250 from CPU memory manager 280. Memory instruction mapper 250 requests from IOMMU 116 the page table mapping for page tables that refer to the address located in the portion of CPU memory resource 270 that is allocated to the SMA in shared memory address space 240. The page table permissions associated with the requested page table mapping deny memory instruction mapper 250 permission to map memory instruction 220 into the portion of CPU memory resource 270 that is allocated to the SMA in shared memory address space 240. IOMMU 116 honors the page table permissions associated with the page table mapping and propagates a page fault from CPU memory manager 280 to memory instruction mapper 250 where memory instruction 250 is denied permission to map memory instruction 220 generated by APD process 210 into CPU memory resource 270.

Page table mapping permission reader 320 in IOMMU 116 can recognize different types of permissions associated with page tables. IOMMU 116 receives a request from memory instruction mapper 250 for memory instruction mapper 250 to receive a page table mapping for PTE 310A-C based on the SMA in shared memory address space 240 referenced by memory instruction 220. Page table mapping permission reader 320 reads the permission for the requested PTE 310A-C. Page table mapping permission reader 320 recognizes either a no-execute permission 315A, an access permission 315B, or a read-only permission 315C for PTE 310A-C. IOMMU 116 grants the proper permission to memory instruction mapper 250 based on the permission read by page table mapping permission reader 320.

An illustrative, non-limiting example of permissions read by page table mapping permission reader 320 is described with reference to FIG. 3, and uses steps and descriptive notes listed below:

G1. In an example, page table mapping permission reader 320 recognizes no-execute permission 315A of PTE 310A. The SMA in shared memory address space 240 is allocated to PTE 310A located in CPU memory resource 270. PTE 310A has no-execute permission 315A. No-execute permission 315A denies memory instruction mapper 250 permission to map memory instruction 220 into CPU memory resource 270. Page table mapping permission reader 320 reads no-execute permission 315A and IOMMU 116 propagates a page fault through to memory instruction mapper 250 from CPU memory manager 280.

G2. In an example, page table mapping permission reader 320 recognizes read-only permission 315C of PTE 310C. The SMA in shared memory address space 240 is allocated to PTE 310C. PTE 310C has read-only permission 315C. Read-only permission 315C limits memory instruction mapper 250 to read the page table mapping for PTE 310C and prohibits memory instruction mapper 250 from writing to PTE 310C. Page table mapping permission reader 320 reads read-only permission 315C. IOMMU 116 limits memory instruction mapper 250 to read the page table mapping for PTE 310C and propagates a page fault from CPU memory manager 280 through to memory instruction mapper 250 attempts to write to PTE 310C.

G3. In an example, page table mapping permission reader 320 recognizes access permission 315B of PTE 31013. The SMA in shared memory address space 240 is allocated to PTE 310B. PTE 310B has access permission 315B. Access permission 315B limits the access memory instruction mapper 250 has to the page table mapping for PTE 310B. Page table mapping permission reader 320 reads access permission 315B. IOMMU 116 limits the access memory instruction mapper 250 has to the page table mapping for PTE 310B based on access permission 315B.

G4. In an example, page table mapping permission reader 320 recognizes supervisor access allowed by access permission 315B of PTE 310B. Supervisor access limits access of the page table mapping for PTE 310B to memory instructions that have supervisor status and generates a page fault to memory instructions that do not have supervisor status.

G5. In an example, memory instruction 220 generated by APD process 210 does not have supervisor status. Access permission 315B with supervisor access denies permission for memory instruction mapper 250 to receive the page table mapping for PTE 310B to map memory instruction 220 into CPU memory resource 270. Page table mapping permission reader 320 reads access permission 315B with supervisor access. IOMMU 116 denies memory instruction mapper 250 the page table mapping for PIE 310B based on access permission 315B with supervisor access and propagates a page fault from CPU memory manager 280 through to memory instruction mapper 250.

G6. In an example, page table mapping permission reader 320 recognizes user access allowed by access permission 315B of PTE 310B. User access allows access of the page table mapping for PTE 310B to memory instructions that have supervisor or user status so that memory instruction mapper 250 can map memory instruction 220 into CPU memory resource 270 based on the page table mapping. PTE 310B has access permission 315B with user access. Memory instruction 220 generated by APD process 210 has user status. Page table mapping permission reader 320 reads access permission 315B with user access. IOMMU 116 grants permission to memory instruction mapper 250 to access the page table mapping for PTE 310B based on access permission 315B with user access so that memory instruction mapper 250 can map memory instruction 220 into CPU memory resource 270 based on the page table mapping.

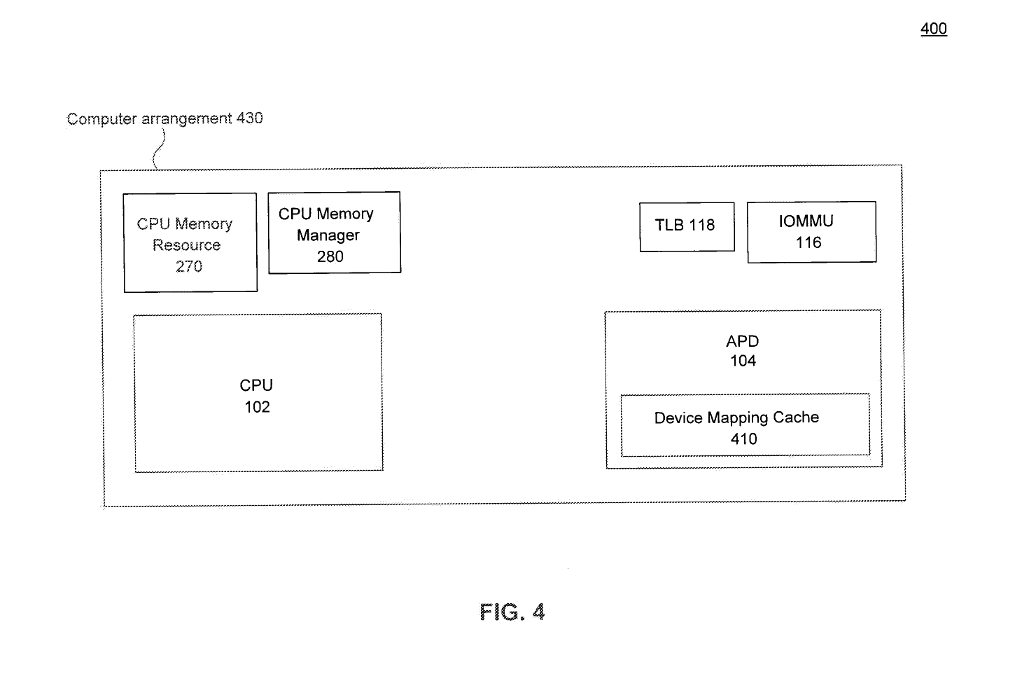

FIG. 4 depicts a system 400, including computer arrangement 430. Computer arrangement 430 includes CPU memory resource 270, CPU memory manager 280, CPU 102, TLB 118, APD 104, IOMMU 116. APD 104 includes device mapping cache 410.

In an embodiment referring to FIGS. 2 and 4, memory instruction 220 originates with APD process 210, and contains an address to shared memory address space 240. Memory instruction mapper 250 uses the included address reference to map memory instruction 220 to CPU memory resource 270. The particular SMA referenced by memory instruction 220 is used by memory instruction mapper 250, to direct the execution of memory instruction 220 to a particular physical memory address accessible by computer arrangement 430.

Referring to FIGS. 2 and 4, based on the address referenced by memory instruction 220 in shared memory address space 240, memory instruction mapper 250 requests a page table mapping for page tables that refer to the address located in the portion of CPU memory resource 270 that is allocated to the SMA in shared memory address space 240. Memory instruction mapper 250 uses the requested page table mapping to map memory instruction 220 to CPU memory resource 270.

As discussed above, with reference to FIGS. 2 and 3, in an approach, memory instruction mapper 250 maps memory instruction 220 to CPU memory resource 270 by requesting a page table mapping from IOMMU 116. In such an embodiment, memory instruction 220 references the SMA in shared memory address space 240 that is allocated to CPU memory resource 270. Memory instruction mapper 250 requests a page table mapping for page tables from IOMMU 116. The page tables requested in the page table mapping refer to the address located in the portion of CPU memory resource 270 that is allocated to the SMA in shared memory address space 240. IOMMU 116 obtains the page table mapping and provides the mapping to memory instruction mapper 250 such that memory instruction mapper 250 uses the requested page table mapping to map memory instruction 220 to CPU memory resource 270.

In a variation on the above described approaches, IOMMU can retrieve the requested page table mapping from TLB 118. As noted in the description of FIG. 1A, TLB 118 can be implemented to accelerate retrieval of page table mappings referencing CPU memory resource 270 for requests made by APD 104. Rather than IOMMU 116 retrieving the page table mapping from CPU memory resource 270, IOMMU 116 can retrieve the page table mapping that is stored in TLB 118.

In this embodiment, memory instruction 220 references the SMA in shared memory address space 240 that is allocated to CPU memory resource 270. Memory instruction mapper 250 requests a page table mapping for page tables from IOMMU 116. The page tables requested in the page table mapping refer to the address located in the portion of CPU memory resource 270 that is allocated to the SMA in shared memory address space 240. IOMMU 116 obtains the page table mapping from TLB 118 and provides the mapping to memory instruction mapper 250 such that memory instruction mapper 250 uses the requested page table mapping to map memory instruction 220 to CPU memory resource 270.

In another variation, instead of requesting a page table mapping from IOMMU 116, memory instruction mapper 250 maps memory instruction 220 to CPU memory resource 270 by requesting a page table mapping from device mapping cache 410. Device mapping cache 410 can be implemented to accelerate retrieval of page table mappings referencing CPU memory resource for requests made by APD 104. Rather than IOMMU 116 retrieving the page table mapping from CPU memory resource 270 or TLB 118, memory instruction mapper 250 can request the page table mapping from device mapping cache 410 located in APD 104 and accelerate retrieval of the page table mapping.

In this embodiment, memory instruction 220 references the SMA in shared memory address space 240 that is allocated to CPU memory resource 270. Memory instruction mapper 250 requests a page table mapping for page tables from device mapping cache 410. The page tables requested in the page table mapping refer to the address located in the portion of CPU memory resource 270 that is allocated to the SMA in shared memory address space 240. Memory instruction mapper 250 retrieves the page table mapping from device mapping cache 410 located in APD 104 rather than having to go to IOMMU 116 for the page table mapping. Memory instruction mapper 250 uses the requested page table mapping to map memory instruction 220 to CPU memory resource 270.

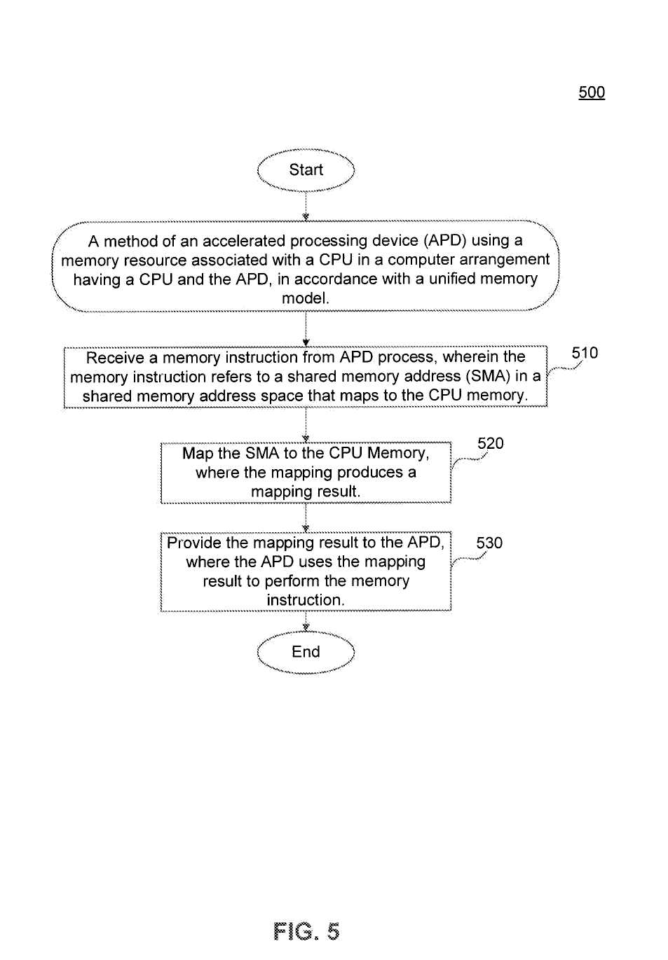

FIG. 5 is an illustration of an exemplary method 500 of an APD using a CPU memory. As shown in FIG. 5, method 500 begins at operation 510 where a memory instruction that refers to a SMA in a shared memory address space that maps to the CPU memory is received from an APD process. In an embodiment, as shown in FIG. 2, a memory instruction receiver, such as memory instruction receiver 252 receives a memory instruction, such as memory instruction 220, that refers to a SMA in a shared memory address space, such as shared memory address space 240, from an APD process, such as APD process 210, that maps to the CPU memory. Once operation 510 is complete, method 500 proceeds to operation 520.

At operation 520, the SMA is mapped to the CPU memory. In an embodiment, as shown in FIG. 2, a memory instruction mapper, such as memory instruction mapper 250, maps the SMA to the CPU memory, such as CPU memory resource 270, where the mapping produces a mapping result. Once operation 520 is complete, method 500 proceeds to operation 530.

At operation 530, the mapping result is used to perform the memory instruction. In an embodiment, as shown in FIG. 2, the mapping result is provided to the APD, such as APD 104, where the APD, such as APD 104, uses the mapping result to perform the memory instruction, such as memory instruction 220. Once operation 530 is completed, method 500 ends.

The foregoing description of the specific embodiments will so fully reveal the general nature of the present invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A method to facilitate operation between a first processor using a memory resource associated with a second processor, comprising:
receiving a memory instruction from a first processor process, wherein the memory instruction refers to a shared memory address (SMA) mapping to the second processor memory;
mapping the SMA to the second processor memory to produce a mapping result; and
providing the mapping result to the first processor.

2. The method of claim 1, wherein the mapping comprises:
requesting a page table mapping result based on the SMA, wherein the page table mapping result maps to an address located in the second processor memory.

3. The method of claim 2, wherein the page table mapping result is further based on a second processor page table map.

4. The method of claim 2, wherein the requesting comprises, requesting the page table mapping result from an input/output memory manager (IOMMU) associated with the first processor.

5. The method of claim 4, wherein the page table mapping result provided by the IOMMU was received from a memory manager associated with the second processor memory.

6. The method of claim 1, wherein the use of the mapping result by the first processor is subject to a page table mapping permission, wherein the page table permission is enforced by a process associated with the first processor.

7. The method of claim 6, wherein the page table mapping permission is a no-execute permission, the computer arrangement being configured to not access a memory address subject to the no-execute permission.

8. The method of claim 6, wherein the first processor portion of the computer arrangement is configured to have an access characteristic, wherein the process associated with the first processor is subject to the access characteristic when attempting to access the second processor memory.

9. The method of claim 8, wherein the page table mapping permission is an access permission, wherein the access permission is configured to limit the access of the page table mapping result by the first processor based on the access characteristic of the first processor.

10. The method of claim 6, wherein the page table mapping permission is a read-only permission, the first processor being configured to read the memory address subject to the read-only permission.

11. The method of claim 1, wherein the first processor stores a received page table mapping result in an first processor mapping cache.

12. The method of claim 1, wherein the first processor comprises an APD and the second processor comprises a CPU.

13. The method of claim 1, wherein the first processor comprises a processor of a first type and wherein the second processor comprises a processor of the first type.

14. The method of claim 13, wherein the first and second processors each comprise an APD.

15. The method of claim 1, wherein the first and second processors each comprise a processor of at least one of the following types of processors: APD, CPU and GPU.

16. A system for a providing a memory resource associated with a second processor to a first processor, comprising:
a memory instruction receiver, configured to receive a memory instruction from a first processor process, wherein the memory instruction refers to a shared memory address (SMA) in a shared memory address space mapping to a second processor memory;
a page table mapper, wherein the page table mapper is configured to:
map the SMA to the second processor memory, wherein the mapping produces a mapping result, and
provide the mapping result to the first processor, wherein the first processor uses the mapping result to perform the memory instruction.

17. The system of claim 16, wherein the page table mapping result includes an address located in the second processor memory and is based on the SMA.

18. The system of claim 16, wherein the page table mapping result is based on a second processor page table map.

19. The system of claim 16, wherein the page table mapper is further configured to request the page table mapping result from an input/output memory manager (IOMMU) associated with the first processor.

20. The system of claim 19, wherein the page table mapping result provided by the IOMMU was received from a memory manager associated with the second processor memory.

21. The system of claim 16, wherein the page table mapper is further configured to receive a page table permission associated with the mapping, the first processor being configured to enforce the page table permission.

22. The system of claim 21, the page table mapper is further configured to receive a no-execute permission, the first processor being prohibited from accessing the page table mapping result.

23. The system of claim 21, wherein the first processor portion of the computer arrangement is configured to have an access characteristic, wherein the process associated with the first processor is subject to the access characteristic when attempting to access the second processor memory.

24. The system of claim 23, the page table mapper is further configured to receive an access permission, the first processor being limited access based on the access characteristic of the first processor.

25. The system of claim 21, the page table mapper is further configured to receive a read-only permission, the first processor being limited to read access for the page table mapping result.

26. The system of claim 16, wherein the first processor stores a received page table mapping result in an first processor cache.

27. The system of claim 16, wherein the first processor comprises an APD and the second processor comprises a CPU.

28. The system of claim 16, wherein the first processor comprises a processor of a first type and wherein the second processor comprises a processor of the first type.

29. The system of claim 28, wherein the first and second processors each comprise an APD.

30. The system of claim 16, wherein the first and second processors each comprise a processor of at least one of the following types of processors: APD, CPU and GPU.
